(19) United States
(12) Patent Application Publication
(10) Pub. No.: US 2008/0087622 A1
(43) Pub. Date: Apr. 17, 2008

(54) Safety timer

(76) Inventor: Daniel Dowd, Pittsburgh, PA (US)

Correspondence Address: CHRISTOPHER D. HARRINGTON, SUITE 350, 5300 CORPORATE GROVE DR, SE, GRAND RAPIDS, MI, 49512, US

(21) Appl. No.: 11/581,255

(22) Filed: Oct. 16, 2006

(51) Int. Cl. A61J 11/00

(52) U.S. Cl. 215/11.1

(57) ABSTRACT

A novel safety timer for use with a baby bottle or the like comprises a timer portion and a band portion, where the band portion is reversibly retained on a baby bottle and holds the timer portion in a position suitable for use. The timer portion provides an indication of the status of the period of use during which the prepared formula is still considered to be safe to offer to the infant. The safety timer of the present invention may also include an identification tag to ensure the association of the baby bottle with a particular infant.

### RELATED APPLICATIONS

Not applicable.

### STATEMENT REGARDING GOVERNMENTALLY FUNDED WORK

Not applicable.

### BACKGROUND OF THE INVENTION

The present invention relates to a safety timer for use with an infant bottle. More particularly, the present invention relates to a safety timer that can be installed onto a baby bottle and set for a select period of time to coincide with the exposure of the baby/infant formula within the bottle to an unrefrigerated environment.

The use of baby or infant formula has been hailed as one of the more important advancements in infant nutrition. Baby formula is typically a scientifically balanced food that is specially designed to assist in providing the essential nutrients, vitamins, amino acids and other dietary requirements that are needed by infants from the day of birth until they are transitioned to other foods. The formula may be prepared from powder with milk being added, or as is believed to be the more common practice, it is commercially prepared and supplied for use in containers that can be kept on the shelf until needed

The amount of formula that may be available in a prepared container, or that might be prepared by the parent from a mix, is usually more than the infant will need for one feeding, which is especially true when the infant is a newborn. Feedings are frequent, but many times will only consist of an ounce or two. The residual quantity of formula is still good for use and the usual recommendation is that upon refrigeration it may be kept for up to 48 hours before it should be discarded. This is an economic issue for parents since the cost of formula is significant and the budgets for many young parents is often stretched anyway.

Recommendations for the handling of warmed formula is very specific. Once the formula has been prepared for use and warmed up for feeding to the baby, it should never be stored away again for future use, even if that use is intended within the next 48 hours. The reason is in the use of the bottle by the baby which introduces enzymes and bacteria into the formula which can thereafter incubate or cause the nutrients to breakdown. Thus any attempt to reuse once-warmed and use baby formula is very risky with respect to the infant's health. Along with these recommendations is another one relating to the period of use allowed for a baby bottle filled with newly minted formula and readied for use. It is urged by those in the field of infant nutrition to use the contents of the baby bottle within one hour once it has been warmed and readied for use.

The time span of one hour may seem like an easily controlled factor when one is considering the use of the prepared formula, but as any young parent can attest, time has a way of getting away from a person when they are contending with a fussy infant, or other children, or trying to manage numerous other household functions while at the same time attending to ht feeding of their baby. Many times young parents in this situation will no longer be able to recall how long the formula has been in use and if the one hour time frame has been reached, or worse, if it has been exceeded. Obviously, parents who are confronting this situation will opt for the safe route and will discard the formula, even if it might in reality there might be plenty of useful time left. The problem is that without some method or way of definitively measuring the time left, the parent will not have any confidence in using the product. Given the cost of formula, this problem represents a significant economic potential; given the potential for harm to the infant, the use of “old” formula represents an even more serious problem for the parents and the baby.

The present invention seeks to solve the foregoing problems and to provide a device and a method for imparting more control over the feeding and nutritional management of infant. As will be discussed in more detail below, the benefits of the present invention will result in less confusion and a greater degree of control over the care of babies and infants.

### SUMMARY OF THE INVENTION

A novel safety timer for use with infant formula comprises a band portion and a timer portion, where the band portion resiliently encircles a baby bottle and is retained thereon, and where the timer portion is installed onto the band portion and is operable by a user for setting a select period of time. The timer, having been set for a select period of time, will preferably disclose the amount of time remaining before the end of the period of time and in one embodiment, the timer may annunciate the end of select period of time.

The band portion of the present invention may also provide an identification tag that can be associated with the particular baby who is to receive the formula.

### BRIEF DESCRIPTION OF THE DRAWINGS

FIG. 1 is an isometric view of a baby bottle with the present invention installed thereon, with the timer portion exposed to view.

FIG. 2 is an isometric view of the safety timer of the present invention with the timer portion exposed and with the identification tag shown.

FIG. 3 is a front view of the safety time of FIG. 2.

FIG. 4 is a rear isometric view of the safety timer of FIG. 2, showing the timer access in the closed condition.

FIG. 5 is a rear isometric view of the safety timer of FIG. 4 with the timer access shown in the open condition.

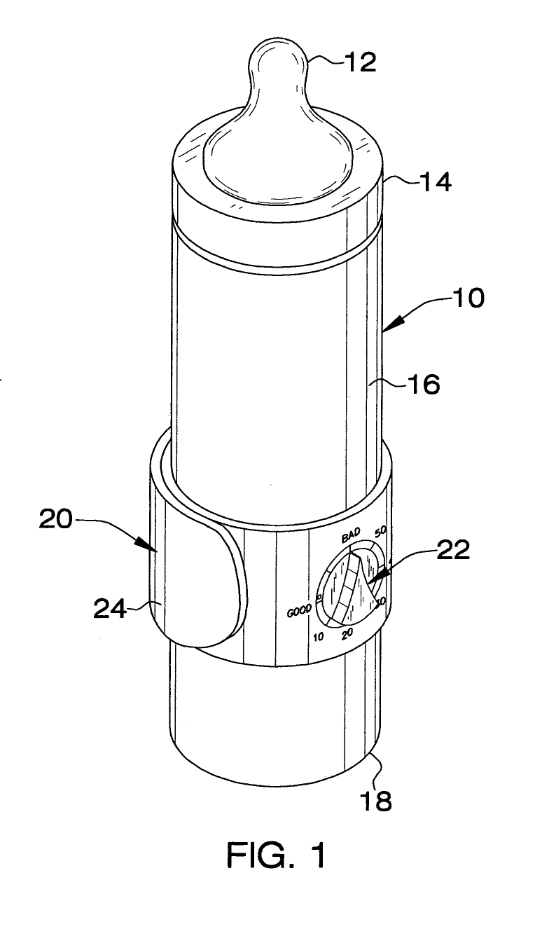

### DETAILED DESCRIPTION OF THE PREFERRED EMBODIMENTS

A novel safety timer for use with baby bottles is disclosed herein in both the drawings and in the specification. In particular, a baby bottle 10 is shown with the nipple 12, the cap 14, the bottle portion 16 which includes the base 18. Disposed about the bottle portion 16 is the safety timer 20 which includes the timer portion 22 and the band portion 24.

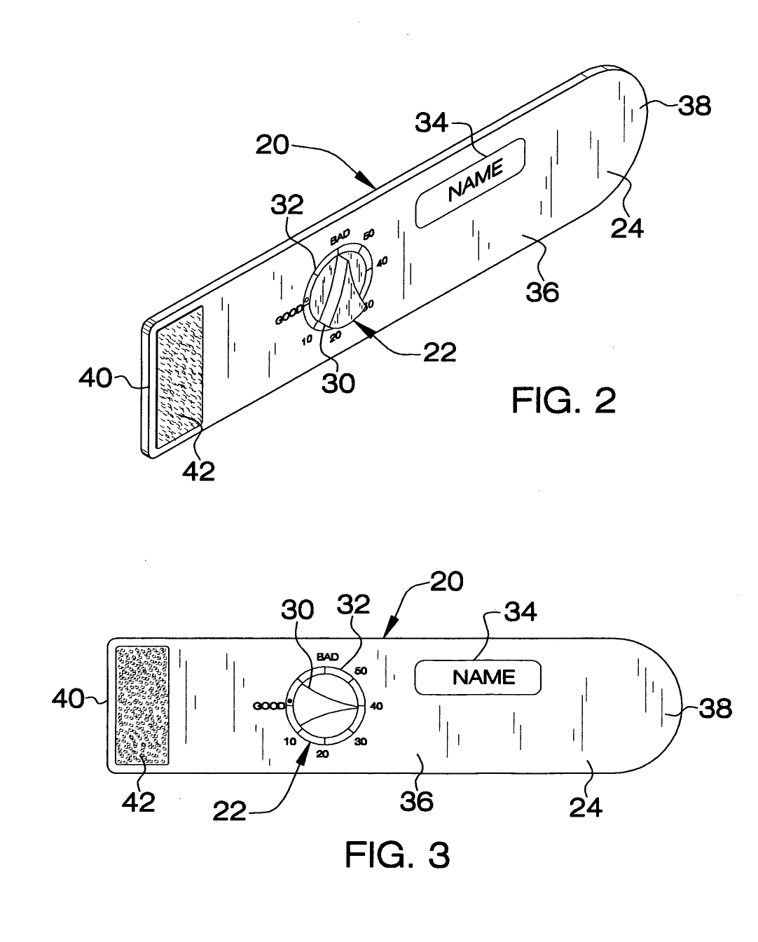

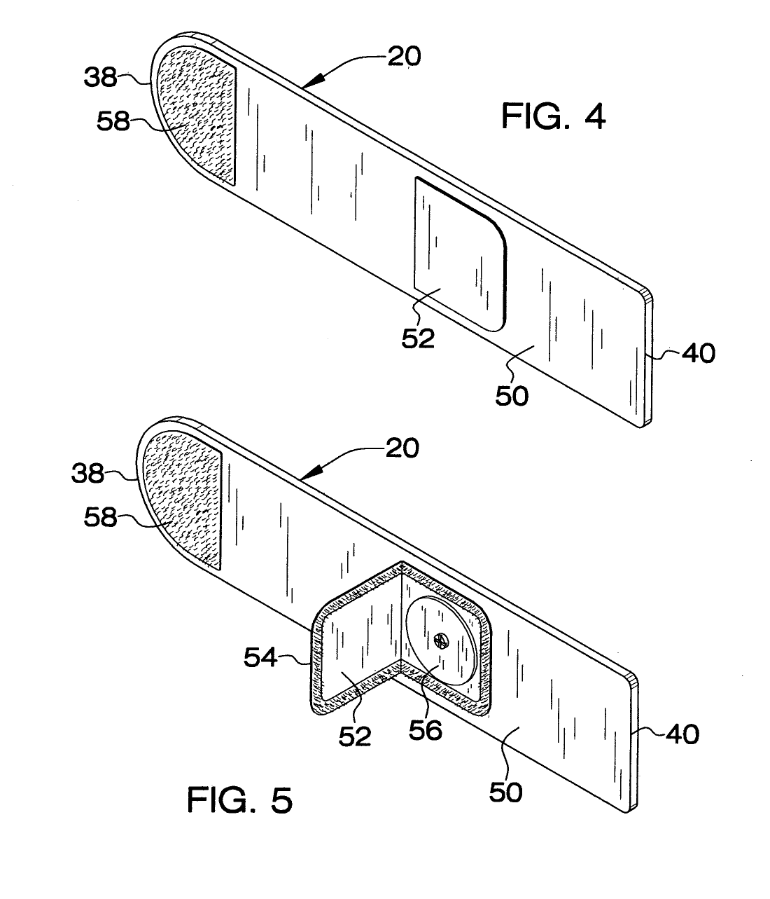

Turning now to FIGS. 2 and 3, more details of the safety timer 20 can be seen, including the timer switch 30, the timer face 32, and the identification tag 34. The band portion 24 is comprised of the band front 36, the leading end 38, the trailing end 40 and with the front flexible fabric fastener 42. More details of the safety timer 20 are shown in FIGS. 4 and 5, with the band rear 50, the timer access 52, the timer access fastener 54, the timer rear 56 and the rear flexible fabric fastener 58.

In use, the safety timer 20 is applied to a bottle 10 to be used by a parent when preparing to feed their infant. As mentioned above, the introduction of formula into the bottle 10, warming it and then presenting it to the infant starts the time running as to when the formula contained in the bottle 10 would need to be discarded. The purpose of the safety timer 20 is to facilitate in this process by providing a visual indication as to how much time is left for each bottle in use and in some cases it may provide an audible alarm as well to indicate when the one hour time limit has been met.

In order to use the safety timer 20, it is initially found in the open condition as shown in FIGS. 2 through 5, and the user may take the trailing end 40 of the band portion 24 and while holding it to the side of the bottle portion 16 the leading end 38 of the safety timer 20 is wrapped around the bottle portion 16. The leading end 38 is secured to the trailing end 40 by attaching the rear flexible fabric fastener 58 to the front flexible fabric fastener 42 which are of the Velcro® type of closure devices. The snugness of the fit of the band 24 around the bottle portion 16 can be, adjusted by adjusting the attachment of the leading end 38 to the trailing end 40. A metal snap could be used between the two ends instead although in order to affirmatively retain the safety timer 20 to the bottle portion 16 it may be required sometimes to have an elastic component embedded in the band portion 24.

Once installed, the safety timer 20 can be activated when the bottle 10 (with the formula in it) is put into use. This period of use is associated with the factors relating to the recommended limitations on the viability of the formula once it has been prepared and presented for use. To activate, the user will turn the timer switch to the 60 minute or “GOOD” position as displayed on the timer face 32. The timer face 32 is incremented so that the age of the prepared bottle 10 is preferentially shown in descending increments until the full 60 minutes runs and the timer switch 30 indicates the “BAD” position on the timer face 32. Obviously the “BAD” indication means that the prepared bottle should not be used any further and the user will discard the contents. In the preferred embodiment, the safety timer 20 would include a green LED (light emitting diode) to provide another means of visual indication to show that the contents of the bottle 10 remained safe to use.

The safety timer 20 can be reused any number of times. An identification tag 34 is preferably included on the band 24 and can be used to identify the bottle 10 as belonging to a particular child, thus avoiding confusion, especially if there are other parents using safety timers 20 in the immediate area. The timer 22 can be strictly a mechanical timer that will accurately time out the 60 minute time frame merely by having the user twist the timer switch 30 from the “BAD” position to the “GOOD” position, and otherwise providing an indication of the remaining time allowed for the period of use. A clockwork type mechanism can be activated in this fashion and depending on the unit; it may terminate in an audible chime or other indication. In an alternate, embodiment, the timer 22 can be battery powered and will increment the 60 minute time frame using an electrical movement for this purpose. An audible alarm can then be provided that will remain on until the user is alerted and takes action to turn it off. In addition, this version would also allow for an LED indication light to activate when the time-out condition is reached. A red LED would be an indication that the bottle 10 is not to be used and may alert the user more easily than by checking the timer face 32, and would obviate the need for an audible alarm which might not be desired when the parent is trying to put the infant to sleep. Access to the timer 22 is provided for by way of the timer access 52 which is a flap that covers the area in the band where the timer 22 is held. Access may be needed at times to completely replace the timer 22, or to allow the band to be laundered, or to replace batteries if the timer 22 is battery powered. The timer access 52 can be opened as shown in FIG. 5 and the use of the flexible fabric fasteners 54 are shown as the method by which the timer access 52 is kept closed.

In other variations on the present invention, the band can be fabricated as a closed loop obviating the leading end 38 and the trailing end 40. In this event it would be preferable to use an elastic type of material to form the band 24 so that it will be retained on the bottle portion 16.

The foregoing represents illustrations as to how the present invention may be used. None of the foregoing is intended to limit the scope of the invention in anyway and other variations on the concept as taught herein may be varied or modified by one skilled in the art without departing from the spirit of the invention.

I claim:

1. A safety timer for use with a baby bottle containing prepared formula, the safety timer being reversibly retained on the baby bottle, the safety timer comprising:
A timer portion comprising a timer for manually setting the time associated with the period of use of prepared formula;
A band portion comprising a band that is reversibly attachable to the baby bottle and where the band portion holds the timer in a position where the timer may be used to set the time for the period of use for the prepared formula; and,
Where the timer provides an indication to the user regarding the period of use.

2. The safety timer of claim Number 1, where the period of use is one hour.

3. The safety timer of claim Number 1, where the safety timer includes an identification tag.

4. The safety timer of claim Number 1, where the band portion has a leading end and a trailing end and where the leading end is attachable to the trailing end in order to secure the band around the circumference of the bottle.

5. The safety timer of claim Number 1, where the band includes an elastic component.

6. A safety timer for use with a baby bottle containing prepared formula, the safety timer being reversibly retained on the baby bottle, the safety timer comprising:
A timer portion comprising a timer for manually setting the time associated with the period of use of prepared formula;
A band portion comprising a band that is reversibly attachable to the baby bottle, where the band portion has a leading end and a trailing end and where the leading end is attachable to the trailing end in order to secure the band around the circumference of the bottle and where the band portion holds the timer in a position where the timer may be used to set the time for the period of use for the prepared formula; and,
Where the timer provides an indication to the user regarding the period of use.

7. The safety timer of claim Number 6, where the period of use is one hour.

8. The safety timer of claim Number 6, where the safety timer includes an identification tag.

9. The safety timer of claim Number 6, where the band includes an elastic component.

10. The safety timer of claim Number 6, where the timer includes a timer face for the displaying the elapsed time for the period of use.

11. The safety timer of claim Number 6, where the timer is battery powered.

12. The safety timer of claim Number 6, where the timer provides an audible indication of the end of the period of use.

13. A safety timer for use with a baby bottle containing prepared formula, the safety timer being reversibly retained on the baby bottle, the safety timer comprising:
A timer portion comprising a timer for manually setting the time associated with the period of use of prepared formula and where the timer is battery powered;
A band portion comprising a band that is reversibly attachable to the baby bottle, where the band portion has a leading end and a trailing end and where the leading end is attachable to the trailing end in order to secure the band around the circumference of the bottle and where the band portion holds the timer in a position where the timer may be used to set the time for the period of use for the prepared formula; and,
Where the timer provides an indication to the user regarding the period of use, the indication comprising at least one form of visual representation of the status of the period of use.

14. The safety timer of claim Number 13, where the timer provides an audible indication of the end of the period of use.

15. The safety timer of claim Number 13, where the timer includes a timer face for the displaying the elapsed time for the period of use.

16. The safety timer of claim Number 13, where the band includes an elastic component.

17. The safety timer of claim Number 13, where the safety timer includes an identification tag.
